(19) United States
(12) Patent Application Publication
(10) Pub. No.: US 2008/0231466 A1
(43) Pub. Date: Sep. 25, 2008

(54) FACILITATING THE COMMUNICATION OF CONNECTIVELY DISSIMILAR WELL SERVICING INDUSTRY EQUIPMENT VIA A UNIVERSAL CONNECTION DEVICE

(75) Inventors: Mehdi Mazrooee, Duncan, OK (US); Ron Dant, Duncan, OK (US); Donald A. Belcher, Duncan, OK (US)

Correspondence Address: JOHN W. WUSTENBERG, P.O. BOX 1431, DUNCAN, OK, 73536, US

(73) Assignee: Halliburton Energy Services, Inc., Houston, TX (US)

(21) Appl. No.: 11/688,095

(22) Filed: Mar. 19, 2007

(51) Int. Cl. G01V 3/00

(52) U.S. Cl. 340/853.1; 340/856.3

(57) ABSTRACT

A wellbore servicing computing network, comprising a first component with a first interface coupled to a connection device, and a second component with a second interface coupled to the connection device; wherein the first component is capable of communication with the second component through the connection device, and wherein the first interface and the second interface are dissimilar; and wherein the first component is oilfield equipment and the second component is a computer. A network for conducting well treatment or well servicing operations, comprising a first node with a first communications interface coupled to a connection device, and a second node with a second communications interface coupled to the connection device, wherein the first node and second node are in communication with each other through the connection device, wherein the first communications interface and second communications interface are dissimilar, and wherein at least one node is coupled to well treating or well servicing equipment capable of assembling at a wellsite to perform a well treatment or well servicing operation.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Local area networks (“LANs”), Wireless local area networks (“WLANs”), and wired connections allow a group of devices (e.g., computers, workstations, printers, file storage devices, and other devices) to communicate and exchange information and share resources over a limited area using a pre-determined software protocol. Each device connected to the LAN, WLAN, and wired connections may be referred to as a “node.” The nodes communicate using a software protocol, which is an electronic method of communicating using a formal set of conventions governing the format and relative timing of electronic messages exchanged between nodes in the LAN. Nodes may be personal computers, equipment used to analyze or take measurements, or any other electronic device capable of signal communication with another node.

In the past, nodes have been forced to utilize matching hardware connections in order to work with hardware equipment. With the evolution of computing standards, hardware connections may exist on equipment, which are not compatible with new computer interfaces. Systems and methods are needed to allow communication between dissimilar interfaces.

### SUMMARY

These and other features and advantages will be more clearly understood from the following detailed description taken in conjunction with the accompanying drawings and claims.

Disclosed herein is a wellbore servicing computing network, comprising a first component with a first interface coupled to a connection device, and a second component with a second interface coupled to the connection device; wherein the first component is capable of communication with the second component through the connection device; and wherein the first interface and the second interface are dissimilar; and wherein the first component is oilfield equipment and the second component is a computer.

Also disclosed herein is a network for conducting well treatment or well servicing operations, comprising a first node with a first communications interface coupled to a connection device, and a second node with a second communications interface coupled to the connection device; wherein the first node and second node are in communication with each other through the connection device; wherein the first communications interface and second communications interface are dissimilar; and wherein at least one node is coupled to well treating or well servicing equipment capable of assembling at a wellsite to perform a well treatment or well servicing operation.

Further disclosed herein is a method of wellbore servicing through network communications, comprising establishing a first electrical connection between a first node and a connection device, establishing a second electrical connection between a piece of well bore servicing equipment and the connection device, selecting a operational mode by the connection device, translating signals transmitted by the first node and the second node, relaying signals between the first node and the well bore servicing equipment, and conducting well site operations.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is an overview of a network containing a signal conversion device.

FIG. 2 is a flowchart of one method of using an embodiment of a signal conversion device.

FIG. 3 is an embodiment of a network containing a signal conversion device.

FIG. 4 is a flowchart of a system which employs the signal conversion device to manually select a mode of operation.

FIG. 5 an embodiment of a signal conversion device.

FIG. 6 is a flowchart of a use of the signal conversion device.

FIG. 7 illustrates several serial interfaces.

FIG. 8 illustrates an exemplary general purpose computer system suitable for implementing the several embodiments of the disclosure.

### DETAILED DESCRIPTION

It should be understood at the outset that although an illustrative implementation of one embodiment of the present disclosure is illustrated below, the present system may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The following definitions are intended to be helpful in clarification, and are not intended to be limiting. Each definition should be interpreted as including, but not limited to, the meaning defined. The phrase “in signal communication” is meant to refer to components which may be electrically connected, coupled, or otherwise configured to directly or indirectly send and receive signals including, but not limited to, electrical signals, radio signals, microwave signals, optical signals, ultrasonic signals, etc. By “in wireless communication”, it is meant to refer to the process whereby electronic devices are in signal communication via any type of wireless technology known in the art suitable for sending and/or receiving communication signals. “Acquired data” includes any information gathered from one or more sources (e.g., sensing devices, keypads, audio microphone, etc.) including, but not limited to, well treatment condition information, vehicle operating condition information, operator input information, etc. “Network information” means any information or data concerning the status of individual nodes or the network as a whole including, but not limited to, information on node identity, node input/output devices, node functionality, network functionality, etc. “Network instructions” means any instructions or commands directed to individual nodes, groups of nodes, or a network as a whole, including, but not limited to, commands related to changes in node functionality, changes in node identity, redeployment of one or more nodes or the entire network, etc. The phrase “hot swap” means the process by which hardware can be electrically connected or coupled without the need to remove power from the device. The phrase “serial format” is intended to refer to the specific implementation of the serial connection, including the connections used to make the serial connection as well as the power requirements required to drive the connection, and the phrase “serial communications” is intended to refer to the mode whereby data is sent one bit at one time, sequentially, over a communications channel or computer bus. The phrase “node functionality” means functions, characteristics and/or parameters associated with an individual piece of equipment associated with a given node (e.g. computer type, connection type), equipment type (e.g., pump truck, blender, delivery truck, master control van), equipment characteristic (e.g., engine model, pump capacity, horsepower, carrying capacity), etc. “Network functionality” means one or more selected or inherent characteristics possessed or performed by a given network, including network algorithms, checklists or other routines.

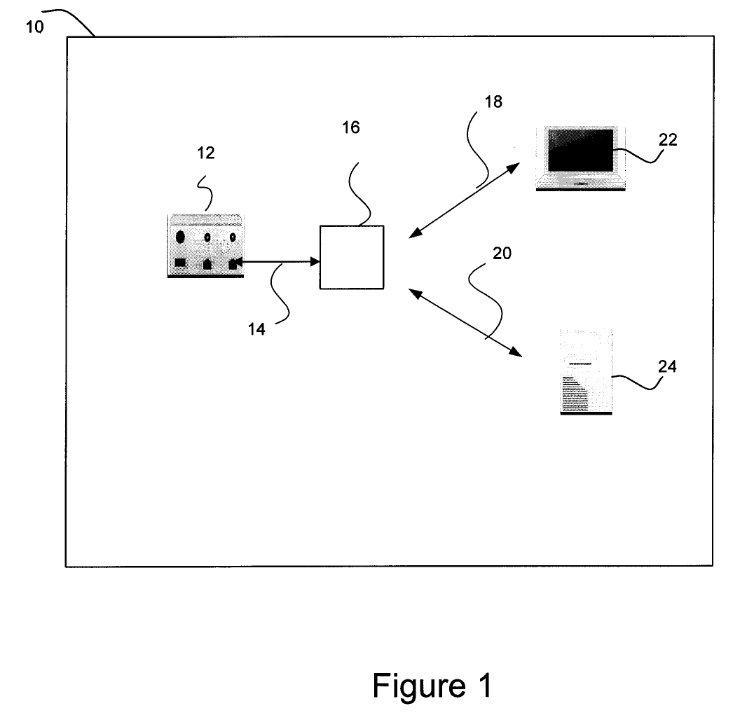

As shown in FIG. 1, the present disclosure contemplates a system 10 wherein a connection device 16 is used to promote communication between equipment 12 through a first connection 14, a first computer 22 through a second connection 18, and second computer 24 through a third connection 20. Connection device 16 may contain any number of connections including, but not limited to, universal serial bus (“USB”) devices, wireless network, wired network, IEEE 1394 (e.g. FireWire, i.Link, Lynx), or other connections. It is further understood that connection device 16 may be used to connect any number and type of electronic devices and any number and type of personal computers. One of the innovative features of connection device 16 is the ability to connect multiple devices to the same equipment with dissimilar connections. Connection device 16 may, in some embodiments, allow for the control of equipment even when one computer has failed. In some embodiments, connection device 16 allows for the ‘hot swapping’ of computers to connection device 16, and for the ‘hot swapping’ of equipment 12 to connection device 16. Hot swapping is intended to refer to the ability to connect and disconnect a computer or equipment to a device, without the need to power off the computer or equipment. In this way, connection device 16 allows for the connection of both first computer 22 and second computer 24 to equipment 12 regardless of the type of connection used by equipment 12 or first computer 22 and second computer 24.

In one embodiment, connection device 16 is capable of translating a signal from equipment 12. One of the innovative features is that connection device 16 may take any serial signal or parallel signal which is transmitted through a signal line and allow it to be used by one of the other devices. Examples of serial connections include, but are not limited to RS-232 serial connections, DB-25 serial connections, Ethernet connections, IEEE1394 connections, and USB connections. It is further contemplated that, in some embodiments, connection device 16 may be capable of signal conversion which allows different types of communication signals to be translated from one type of signal to another through signal translation. Therefore, connection device 16 is capable of promoting connections between dissimilar devices along dissimilar interface connections. One of the innovative features of connection device 16 is the ability to take a first device with a first connection and translate it into another format for a second connection to a second device. It is further contemplated that in addition to acting as a wired node, system 10 is capable of acting as a wireless node. In this way, connection device 16 is capable of communication in both a wired and wireless sense.

The equipment illustrated by FIG. 1 is intended to refer to any electronic equipment capable of performing a function involving both an input and an output. It is expressly understood that one of the problems with existing art is the incompatibility between devices. For instance, serial devices which required a specific kind of serial connection, such as a RS-232c to communicate are incompatible with newer devices which have another type of connection, such as a USB connection or a IEEE 1394 connection.

While all serial connections share the common process of sending data sequentially over a communications channel, not all serial connections are the same. For instance, a DE-9 serial connection contains nine separate connections: carrier detect, a receive data (usually +/−12V), transmit data (usually +/−12V), data terminal ready, system ground, data set ready, request to send, clear to send, and ring indicator, each of which are part of the signal. As data speeds have increased, the standard for port configuration has changed. For instance, a USB connection contains only four separate connections: a voltage bus (“VBUS”) which operates between approximately 4.75 and 5.25 volts, a D−, a D+, and ground. One of the innovative features of connection device 16 is the ability to take a signal from one serial format and convert it to another serial format. Systems and methods of amplifying or reducing a signal are known to one skilled in the art.

In addition to enabling the translation of signals, additional data may be added or removed to translate signals from one signal interface to another. For instance, in some serial connections, a specific signal is needed such as a clear to send (“CTS”) signal. In these embodiments, connection device 16 will emulate the required signals in order to conform to the serial connection requirements. It is expressly understood that the disclosed embodiments are capable of adding and stripping data from one source to another.

Another method of transferring data is through the parallel port. In parallel communication, sent through a parallel port, multiple data streams are sent simultaneously. If the serial port were a highway, it might be analogized to a highway with one lane in each direction. If the parallel port was a highway, it might be analogized to a highway with several lanes in each direction. Parallel communications also require adjusting the same two elements: the signal and the signal voltage. One of the innovative features of connection device 16 is the ability to translate the parallel port data stream into a serial data stream or vice-versa. This is accomplished by interleaving the parallel data into packets of known length by connection device 16, then ordering the packets into a serial stream and transmitting them through connection device 16.

It is contemplated that several modes of operation are possible for the connection device 16 including, but not limited to transmission, conversion, and splitting. In the first mode, transmission, a signal received from equipment 12 is passed directly to connection device 16, and then passed to first computer 22 or second computer 24. In the second mode, conversion, a signal is transmitted from equipment 12 to connection device 16, converted from a first signal type to a second signal type by connection device 16, and transmitted to first computer 22 or second computer 24 In the third mode, splitting, a signal a signal received from equipment 12 is passed directly to connection device 16, and then passed to first computer 22 or second computer 24 While each of these modes are show separately, it is explicitly understood that any number of the modes could be used together (e.g., a signal could undergo both conversion and splitting). It is further understood that while the examples illustrated show a signal being propagated from equipment 12, it is explicitly understood that any of the aforementioned methods could be used by first computer 22, second computer 24, or both first computer 22 and second computer 24 to transmit a signal to equipment 12.

It should also be understood that an additional advantage of this disclosure is that in one embodiment of the disclosed systems, two or more computers may be in signal communication (e.g., by wireless and/or hardwire communication) to cooperatively accomplish one or more operational tasks, such as a well treatment operation, and/or to perform two or more separate operational tasks simultaneously (related or unrelated) with legacy devices or other devices through connection device 16. It is further understood that in the case of a fault of a first computer, a second computer, third computer, or other device could connect, or be used to monitor one or more operational tasks, such as a recovery operation. Examples of information that may be exchanged between equipment 12 and first computer 22 include, but are not limited to, network information, network instructions, acquired data, etc.

It is contemplated that connection device 16 may further allow for redundancy, as multiple computers may be attached to a single equipment 12, and, in addition, connection device 16 may be further capable of wirelessly transmitting a reformatted data stream. In some embodiments, where connection device 16 is equipped with WiMAX, Global System for Mobile Communications (“GSM”), Enhanced Data GSM Environment (“EDGE”), General Packet Radio Service (“GPRS”), or other long range wireless standards, connection device 16 may relay status information regarding first computer 22, second computer 24, or equipment 12 back to a remote location. Unlike short range WLAN configurations where there is a need for a local WLAN node location (e.g. within 100 ft), the decentralized long range network removes the equipment from the wellsite, and allows for enhanced network stability through the use of existing networks as well as increased safety as demolitions or other charges used at a drill site will not be exposed to high power low range WLAN signals. In this manner, the remote location may monitor sites based upon connection device 16 without the need for a local WLAN infrastructure. The remote data transmission capabilities of the disclosed long range wireless networks eliminate the need for engineers or other specialists to travel to these remote sites.

It should be understood that one benefit of this disclosure that other well treatments and well services employing equipment 12 known in the well servicing art may also be performed using embodiments of the disclosed connection device 16. Such well treatments and services include, but are not limited to, treatment or services related to acidizing, condensate treatments, injectivity testing, gravel packing, frac packing, introduction of drilling fluids into a wellbore, etc. Other examples of well service operations (and/or related equipment) which may be advantageously performed and/or equipped using embodiments of the disclosed connection device 16 include, but are not limited to, perforating operations, coiled tubing operations, drilling and workover rig operations, as well as any other type of well service operation employing one or more pieces of mobile equipment (including, but not limited to, equipment that is truck-mounted, trailer-mounted, skid-mounted, barge-mounted, etc.). Since the equipment that is truck-mounted may vary in the connectivity available, connection device 16 can allow the equipment to be operated by any machine which is available. Connection device 16 will further allow for damaged or malfunctioning equipment to be operated by a secondary machine without the need to remove existing hardware.

In one exemplary embodiment of the disclosed system, oil well stimulation equipment may be transported by vehicle to job sites controlled or monitored by computer 22 or other device connected through connection device 16. In the case of a fault in computer 22, connection device 16 may, in some embodiments, announce this fault condition to another node. In this situation, second computer 24 may be hot swapped into connection device 16 to control the oil well stimulation equipment, even if second computer 24, first computer 22, and the oil well stimulation equipment do not have a common type of port.

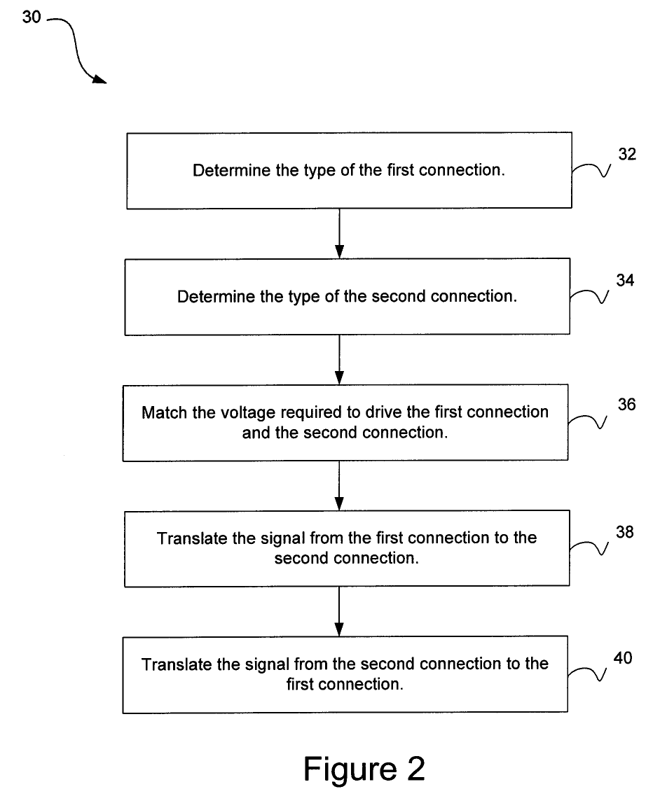

FIG. 2 is a flowchart 30 of one embodiment of a method used by connection device 16 to translate a signal from a first connection to a second connection. In this embodiment, connection device 16 determines the type of the first connection (Block 32). The type of connection includes whether the connection is serial or parallel, the voltage requirements of the port, and the data format used to transmit information through the port. The signal conversion device also determines the type of the second connection (Block 34). One of the innovative features of connection device 16 is to match the voltage required to drive the first connection and the second connection (Block 36). Based on the determination of the type of the first connection and the type of the second connection, connection device 16 translates the signal from the first connection to the second connection (Block 38). In addition, connection device 16 translates the signal from the second connection to the first connection (Block 40). In this way, connection device 16 allows for nodes to communicate with one another without the need to have the same interface connection.

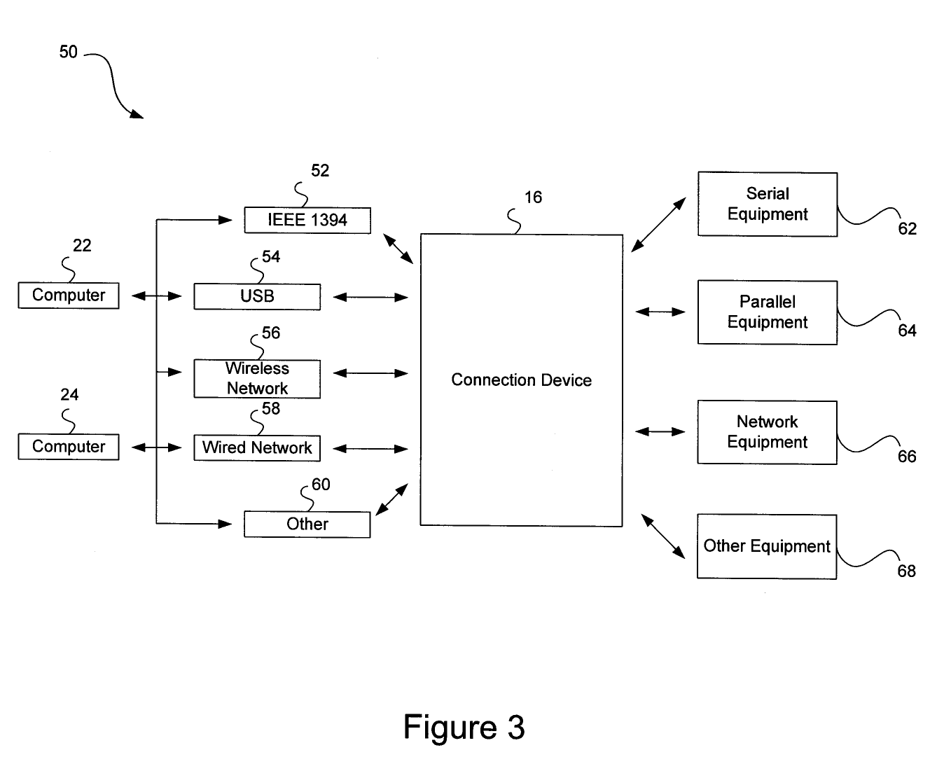

FIG. 3 is a block diagram 50 of connection device 16 and devices which may be attached through it. Connection device 16 may be connected to any kind of equipment, including a serial equipment 62, a parallel equipment 64, a network equipment 66, and other equipment 68. Connection device 16 may, in some embodiments, have different hardware ports which designate the type of connection, and, in other embodiments, have software detection. For instance, a parallel port and a serial port may have the same physical connection, but very different operation. Therefore, it is expressly understood that connection device 16 may have additional ports in which to connect other device. In addition, first computer 22 and second computer 24 may be connected to connection device 16 though any number of methods, including, but not limited to IEEE 1394 52, USB 54, Wireless Network (e.g. 808.11, WiMax, GPRS, Satellite communications) 56, wired network (e.g. ethernet) 58, and other connections 60. It is further contemplated that a local hub, or device which allows for multiple devices to be daisy chained to it, may be directly connected to connection device 16.

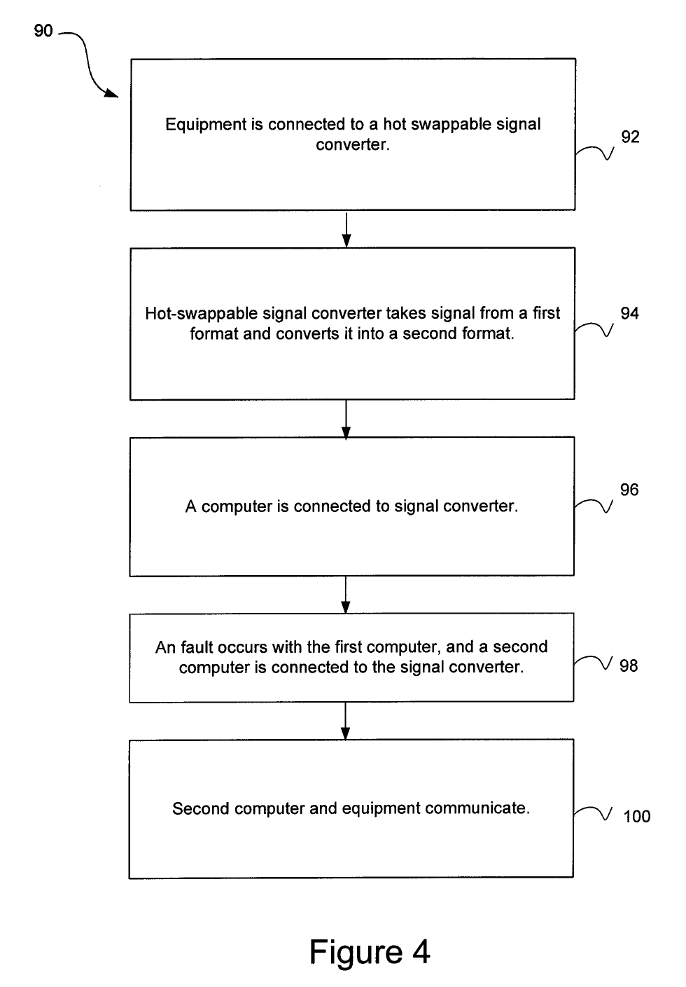

FIG. 4 is a flowchart 90 of an embodiment of the present disclosure wherein an operational mode may be manually be selected by a user during a fault by a computer connected to connection device 16. In this example, a fault develops with first computer 22 in the configuration shown in FIG. 1, a second computer 24 could be added to connection device 16, and second computer 24 could subsequently take control of equipment 12. One example of the usefulness of this embodiment is a situation where a computer located at a well site experiences a failure, a computer that is located in another location, or a portable computer carried to the well site, may be used to connect to connection device 16 without the need to remove the equipment or restart the equipment connected to connection device 16. In this embodiment, equipment 12 is connected to a hot swappable signal converter (Block 92). Hot-swappable signal converter takes signal from a first format and converts it into a second format (Block 94). A computer is connected to signal converter (Block 96). At this stage communication may commence between the first computer and the equipment. However, if a fault occurs with the first computer, a second computer may be connected to the signal converter to allow for the control of the equipment without the need to remove the first computer. (Block 98). Second computer and equipment communicate without the need to remove the first computer from the signal converter (Block 100). In this way, drill site operations may continue without the need to remove faulty equipment.

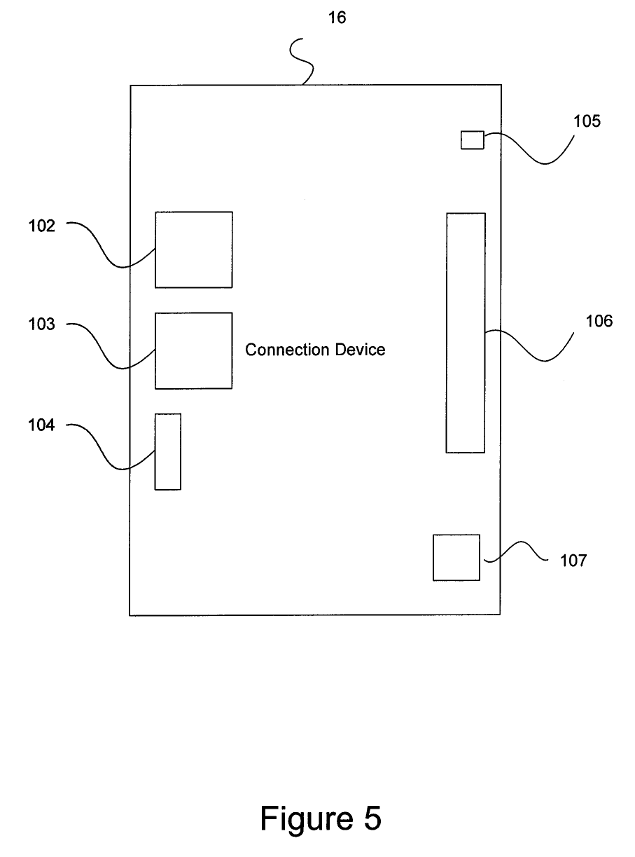

FIG. 5 is a block diagram of connection device 16. A first port 102, a second port 103, and third port 104 are located on connection device 16. First port 102, second port 103, and third port 104 may be a serial connection (e.g. RS232, USB, etc.), parallel connection, wireless antenna, or any other port or mechanism capable of transmitting or receiving signals. Indicator 105 is also illustrated on connection device 16 may be implemented as a light emitting diode (“LED”) and can be used to determine the operating status of connection device 16. Connection device 16 also includes liquid crystal display (“LCD”) 106 which may be used to display information regarding the signals being converted in connection device 16. Mode selection switch 107 may allow for a user to select a mode between transmission, conversion, and splitting operating modes.

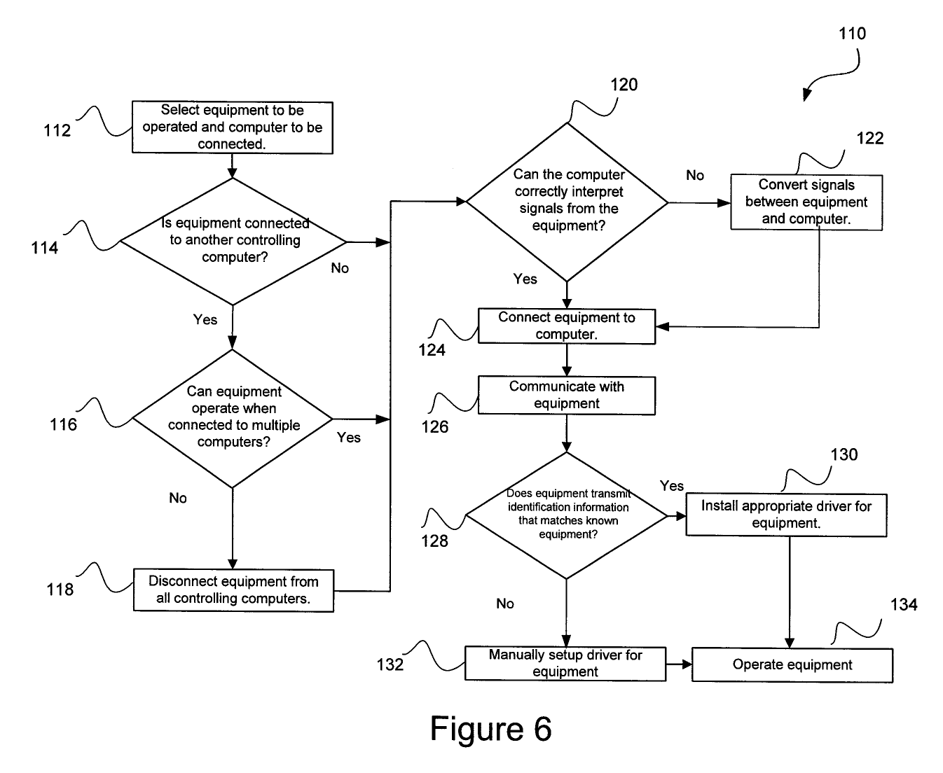

FIG. 6 is a flowchart 110 of one method of implementing connection device 16. In this flowchart equipment 12 to be operated and first computer 22 to be connected are selected (Block 112). The operator will identify whether equipment 12 is currently being controlled by a second computer 24 (Block 114). If equipment 12 is being controlled by second computer 24, then connection device 16 must determine if equipment 12 can be operated when connected to multiple computers (Block 116). If equipment 12 is not being controlled by second computer 24, then connection device 16 will determine if first computer 22 can correctly interpret signals from the equipment 12 (Block 120). If connection device 16 determines that equipment 12 can be operated when connected to multiple computers, connection device 16 will determine if computer 22 can correctly interpret signals from the equipment 12 (Block 120). If connection device 16 determines that equipment 12 cannot be operated when connected to multiple computers, connection device 16 must disconnect equipment from second computer 24 (Block 118) and then will determine if first computer 22 can correctly interpret signals from the equipment 12 (Block 120).

FIG. 6 continues when connection device 16 determines if first computer 22 can correctly interpret signals from the equipment 12 (Block 120). If connection device 16 determines that first computer 22 can correctly interpret signals from the equipment 12 it will connect first computer 22 to equipment 12 (Block 124). If connection device 16 determines that first computer 22 cannot correctly interpret signals from the equipment 12, connection device 16 will convert the signals between equipment 12 and second computer 22 (Block 122), then it will connect first computer 22 to equipment 12 (Block 124). After first computer 22 and equipment 12 are connected, communication can proceed (Block 126). It is explicitly understood that for some connections, such as null connections, drivers may not be necessary, but that for other connections, such as USB connections, drivers will be required. This type of connection will require that equipment 12 be recognized by first computer 22. If equipment transmits identification information that matches known equipment (Block 128), then first computer 22 will automatically install an appropriate driver for equipment 12 (Block 130), and then the user may operate the equipment 12 (Block 134). If equipment transmits identification information that does not match known equipment (Block 128), then first computer 22 will require the user to manually install an appropriate driver for equipment 12 (Block 132), and then the user may operate the equipment 12 (Block 134).

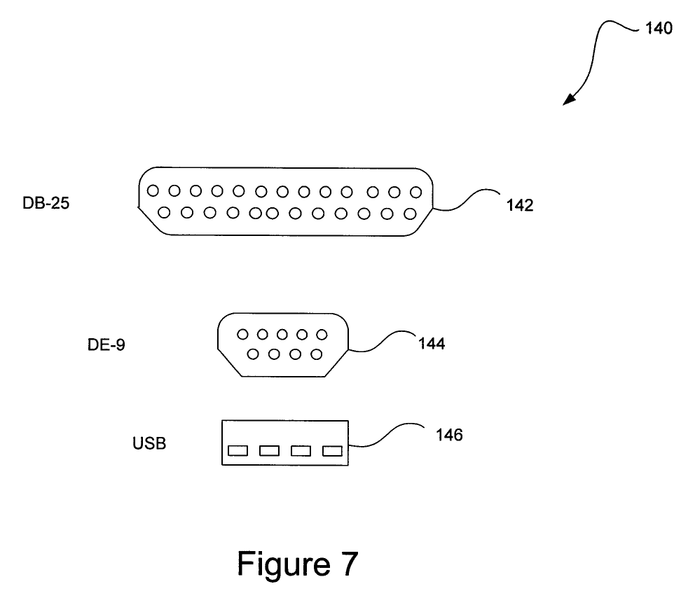

FIG. 7 illustrates the physical incompatibility of several types of serial devices 140 which can be connected to connection device 16. One of the innovative features of connection device 16 is the ability to connect to several devices with physically incompatible standards. In this example, a DB-25 25 pin serial connection 142, a DE-9 (RS-232C) connection 144, and USB connection 146 are shown. Each of these serial devices shown is both electrically and physically incompatible, and therefore requires an intermediate device to allow for interoperability between devices.

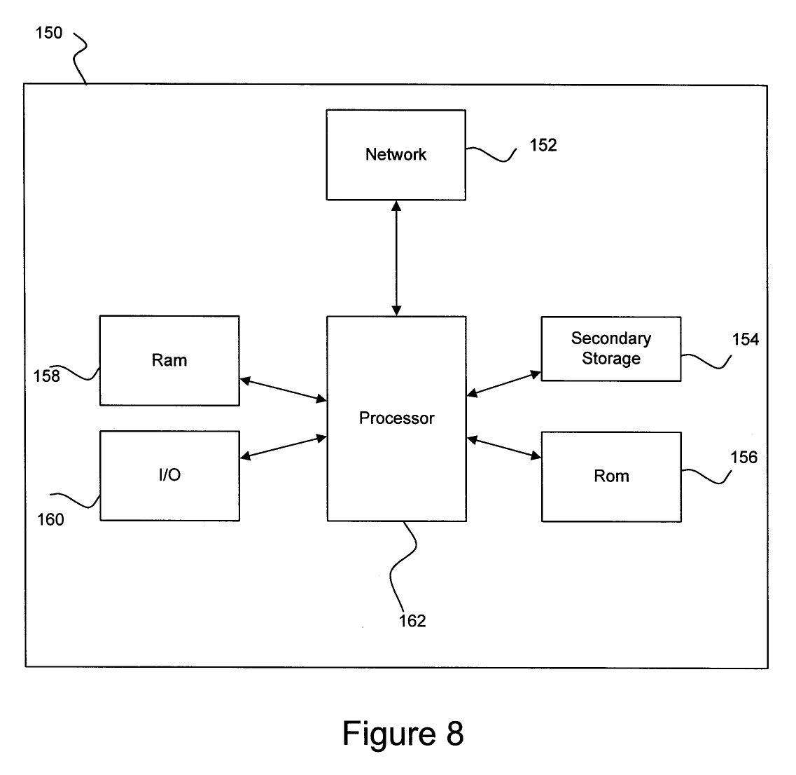

The connection device 16 described above may be implemented on any general-purpose computer with sufficient processing power, memory resources, and network throughput capability to handle the necessary workload placed upon it. FIG. 8 illustrates a typical, general-purpose computer system suitable for implementing one or more embodiments disclosed herein. The computer system 150 includes a processor 162 (which may be referred to as a central processor unit or CPU) that is in communication with memory devices including secondary storage 154, read only memory (“ROM”) 156, random access memory (“RAM”) 158, input/output (“I/O”) devices 160, and network connectivity devices 152. The processor may be implemented as one or more CPU chips.

The secondary storage 154 is typically comprised of one or more disk drives or tape drives and is used for non-volatile storage of data and as an over-flow data storage device if RAM 158 is not large enough to hold all working data. Secondary storage 154 may be used to store programs which are loaded into RAM 158 when such programs are selected for execution. The ROM 156 is used to store instructions and perhaps data which are read during program execution. ROM 156 is a non-volatile memory device which typically has a small memory capacity relative to the larger memory capacity of secondary storage. The RAM 158 is used to store volatile data and perhaps to store instructions. Access to both ROM 156 and RAM 158 is typically faster than to secondary storage 154.

I/O devices 160 may include printers, video monitors, LCDs, touch screen displays, keyboards, keypads, switches, dials, mice, track balls, voice recognizers, card readers, paper tape readers, or other well-known input devices. The network connectivity devices 152 may take the form of modems, modem banks, ethernet cards, USB interface cards, parallel interfaces, serial interfaces, token ring cards, fiber distributed data interface (“FDDI”) cards, WLAN cards, radio transceiver cards such as code division multiple access (“CDMA”) and/or GSM radio transceiver cards, and other well-known network devices. These network connectivity devices 152 may enable the processor 162 to communicate with an Internet or one or more intranets. With such a network connection, it is contemplated that the processor 162 might receive information from the network, or might output information to the network in the course of performing the above-described method steps. Such information, which is often represented as a sequence of instructions to be executed using processor 162, may be received from and outputted to the network, for example, in the form of a computer data signal embodied in a carrier wave.

Such information, which may include data or instructions to be executed using processor 162 for example, may be received from and outputted to the network, for example, in the form of a computer data baseband signal or signal embodied in a carrier wave. The baseband signal or signal embodied in the carrier wave generated by the network connectivity devices 152 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 162 executes instructions, codes, computer programs, and scripts which it accesses from hard disk, floppy disk, optical disk (these various disk based systems may all be considered secondary storage 154), ROM 156, RAM 158, or the network connectivity devices 152.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A wellbore servicing computing network, comprising:
a first component with a first interface coupled to a connection device; and
a second component with a second interface coupled to the connection device;
wherein the first component is capable of communication with the second component through the connection device; and wherein the first interface and the second interface are dissimilar; and wherein the first component is oilfield equipment and the second component is a computer.

2. The wellbore servicing computing network of claim 1, wherein the first component is used in oil field operations related to acidizing, condensate treatments, injectivity testing, gravel packing, frac packing, and introduction of drilling fluids into a wellbore.

3. The wellbore servicing computing network of claim 2, wherein the first interface is a serial, a parallel, or a network connection.

4. The wellbore servicing computing network of claim 2, wherein the first component is operable to perform coiled tubing operations, drilling operations and workover rig operations.

5. The wellbore servicing computing network of claim 4, wherein the third component is capable of being hot swapped to the connection device.

6. The wellbore servicing computing network of claim 5, wherein the third interface is a IEEE 1394 or universal serial bus interface.

7. The wellbore servicing computing network of claim 1, wherein at least one of the first interface and the second interface is dynamically configurable by the connection device within said network.

8. A network for conducting well treatment or well servicing operations, comprising:
a first node with a first communications interface coupled to a connection device; and
a second node with a second communications interface coupled to the connection device; wherein the first node and second node are in communication with each other through the connection device; wherein the first communications interface and second communications interface are dissimilar; and wherein at least one node is coupled to well treating or well servicing equipment capable of assembling at a wellsite to perform a well treatment or well servicing operation.

9. The network for conducting well treatment or well servicing operations of claim 8, wherein the electrical connection is a serial connection or a parallel connection.

10. The network for conducting well treatment or well servicing operations of claim 8, wherein the first node has a first connection and a second node has a second connection.

11. The network for conducting well treatment or well servicing operations of claim 10, wherein the connection device is capable of translating a first connection into the second connection.

12. The network for conducting well treatment or well servicing operations of claim 10, further comprising a third node connected to the connection device; and wherein the third node is capable of communicating with the first node and second node.

13. The network for conducting well treatment or well servicing operations of claim 12, wherein the connection device creates a direct connection between the third node and first node without disconnecting the second node.

14. A method of wellbore servicing through network communications, comprising:
establishing a first electrical connection between a first node and a connection device;
establishing a second electrical connection between a piece of well bore servicing equipment and the connection device;
selecting a operational mode by the connection device;
translating signals transmitted by the first node and the second node;
relaying signals between the first node and the well bore servicing equipment; and
conducting well site operations.

15. The method of wellbore servicing through network communications of claim 14, wherein the operational mode is transmission, conversion, or splitting operational mode.

16. The method of wellbore servicing through network communications of claim 15, wherein the operational mode allows for hot swappable connections between the first node and the second node.

17. The method of wellbore servicing through network communications of claim 15, further comprising placing a well service fluid and/or tool down hole.

18. The method of wellbore servicing through network communications of claim 17, wherein the first node has a first serial interface and the second node has a second serial interface, wherein the first serial interface and the second serial interface are dissimilar.

19. The method of wellbore servicing through network communications of claim 18, wherein the connection device is capable of communicating through a wired or wireless device.

20. The method of wellbore servicing through network communications of claim 18, wherein the connection device is capable of translating a signal from a first serial connection to a second serial connection by adding and removing clear to send data.
